(19) United States
(12) Patent Application Publication
(10) Pub. No.: US 2009/0192777 A1
(43) Pub. Date: Jul. 30, 2009

(54) Method for Estimating a Noise Generated in an Electronic System and Related Method for Testing Noise Immunity

(75) Inventors: Francois Jean Raymond Clement, Virieu Sur Bourbre (FR); Amine Dhia, Grenoble (FR); Benoit Emmanuel Fabin, Grenoble (FR)

Correspondence Address: FULBRIGHT & JAWORSKI, LLP, 666 FIFTH AVE, NEW YORK, NY, 10103-3198, US

(73) Assignee: COUPLING WAVE SOLUTIONS CWS, MOIRANS (FR)

(21) Appl. No.: 12/223,737

(22) PCT Filed: Feb. 2, 2007
(86) PCT No.: PCT/FR2007/050740

§ 371 Date: Aug. 7, 2008

(30) Foreign Application Priority Data
Feb. 7, 2006 (FR) 0650438

(51) Int. Cl. G06F 17/50

(52) U.S. Cl. 703/16

(57) ABSTRACT

The invention concerns a method for testing immunity to noise derived from interferences between components in a mixed analogic and digital electronic system. The method comprises determining by simulating the highest-level noise observed in the system, or the worst noise generated by interferences. If a test for noise sensitivity is successful with this injected worst noise, then the system is accepted. In the case where the worst noise test fails, the method comprises calculating by simulating the lowest-level noise observed in the system, or the injected best noise. If a test for noise sensitivity fails with this injected best signal, then the system is rejected.

The present invention relates to a method for estimating the noise generated in an electronic system and a related method for testing immunity. The invention is aimed especially at determining the efficient operation or malfunctioning of the system through an analysis of a noise in this system. The invention can be applied to particular advantage in the field of combined electronic systems comprising analog and digital components. Non-exhaustive examples of such systems are electronic systems containing integrated circuits on a single silicon block or on several silicon substrates in a same package as well as assemblies of components (whether integrated or not) on a printed circuit.

The manufacture of these electronic systems is a highly costly operation, especially when the system has one or more components integrated on silicon. Thus, before starting large-scale manufacture, it is indispensable to control all the manufacturing parameters and to give values to certain parameters so as to maximise the probability that the manufactured circuit will work well.

To this end, there is a set of software products called “electronic design automation tools” used to assist in the designing of electronic systems, starting from the description of the specifications of the system to be made up and going up to the making of the photographic masks used in the manufacture of the system.

One of the major elements used to design an electronic system is the quantifying of the noise produced by the circuits, especially in a combined system. To this end, the method identifies the noise-generating circuits (known as aggressors) and the noise-sensitive circuits (known as victims).

More specifically, the circuits of the system can all be considered to be noise-generators (aggressors). However, it is preferable to choose noise-generating circuits from the group comprising: digital circuits, memory cells, analog and radio-frequency (RF) circuits such as VCOs (voltage control oscillators), power amplifiers and input/output circuits. In particular, digital circuits tend to generate noise when their input signals are switched over. Naturally, a circuit having at least one noise-generating circuit is itself considered to be a noise-generating circuit.

Noise-sensitive circuits (or victims) are chosen from the group comprising: analog and RF circuits, such as amplifiers, filters, oscillators, mixers, sample-and-hold circuits, memory type digital circuits, phase-locked loops, input/output circuits and voltage references. Naturally, a circuit comprising at least one noise-sensitive circuit is itself considered to be a noise-sensitive circuit.

The noise generated by the aggressors spreads towards the victims, in passing through the substrate on which the circuits are mounted, the metallic interconnections and the packages. This noise tends to impair the performance of the victims. Thus, the term “noise” is understood to mean any signal generated by an aggressor block which has an undesired effect on the victims.

Software programs such as SPICE are used to analyse the effects of the aggressor blocks on the victims. To this end, impedance models are added to the SPICE models of the original combined system to model the substrate. It is thus possible to analyse the effect on the victims of the noise injected by the aggressors through the substrate. However, for big electronic systems comprising several millions of transistors or logic gates, typically when the system comprises integrated circuits, the SPICE models need an excessive amount of system resources. For these big systems, the methods implemented are rather those that use approximate models of the substrate and model the injection of noise into this substrate by current sources.

There is thus the known method described in the U.S. Pat. No. 6,941,258, in which an integrated circuit consisting of a set of cells is considered. A cell is an elementary system of the analog or digital type circuit. A cell fulfils a given function and may, for example, take the form of a logic gate or a set of logic gates.

Each cell has an associated macro-model which models the noise injected by the cell into the substrate, the parasitic elements of the cell and the connection with the rest of the system. This macro-model comprises current sources which inject a noise current into the substrate, for example, a switching noise-current generated by the cell. Furthermore, the macro-model comprises resistors, capacitors and possibly inductors which model the links between the terminals of the cell, the power supply nodes and the connection to the substrate.

To extract the current sources from the macro-model, the noise-current injected by the cell is computed by using a very detailed model of simulation of the cell. The noise associated with a cell is then computed by causing its inputs to be switched over. Switching patterns that characterize the passage of the inputs of the cell from one state to another are thus defined for a given extraction phase. And, during an application of these switching patterns to the input terminals of a cell, the noise-generating currents of this cell are measured and extracted.

To compute the total noise of the circuit, the macro-models of the cells and the noise signals that they generate are combined by introducing a switching delay between the changes in state of the cells. For, these cells do not all inject noise at the same time into the substrate. Thus, the macro-models and the noise signals are combined according to a model of the switching instants of the cells of the circuit.

In practice, the method presented in the document U.S. Pat. No. 6,941,258 proposes to compute a total macro-model of the entire circuit which is a combination of the macro-models of the cells of the circuit, while at the same time taking account of the shifts in the injection of noise by the cells into the rest of the integrated circuit. The noise sources of this total macro-model are thus combinations of the noise sources of the macro-models of each cell.

A noise-computation method of this kind is used to simulate the observable noise in a single integrated circuit on silicon and gives results close to reality. Indeed, the result of this simulation is close to the result obtained by an all-transistor simulation of the digital circuit. However, a simulation method of this kind cannot be used to make any definite assertion about the efficient operation of a circuit. Indeed, this method determines the noise injected solely into the substrate of the integrated circuit and in particular does not take account of the noise associated with the interconnections of the cells with one another whether on silicon, in packages or on a printed circuit.

Furthermore, this method is a closest simulation that provides a precise idea of the medium noise generated by the digital circuits. However, this method does not take account of cases of marginal operation of the system in terms of switching activity nor of a random factors in production that could impair the performance of the system.

The present invention therefore proposes to provide information of greater relevance on the noise injected into the electronic system so that it becomes possible to find out with certainty if the desired operation of the system is appreciably affected or not affected by the noise injected by its cells, especially by its digital cells.

To this end, a computation is made, in the invention, in a worst case, of the greatest noise that can be observed in the system. In one mode of implementation, to compute this noise, all the cells inject the greatest noise that they can inject into the system.

If a test of noise sensitivity is successful in the worst case, i.e. if the noise computed in the system is below the tolerance thresholds of the sensitive circuits, then it is deduced from this that the system, in its best and worst conditions of operation in terms of noise and with its random factors of production, will be insensitive to the noise created by its digital cells. In this case, no additional test is necessary.

By contrast, if the test fails, i.e. if the noise computed in the system is greater than the tolerance thresholds of the sensitive circuits, then a computation is made by simulation, in the best case, of the lowest possible noise that can be observed in the system. In one mode of implementation, to compute this noise, all the cells inject the lowest noise that they can inject into the system.

If the test of noise sensitivity fails in this best case, then the architecture of the system is greatly open to question, and very often it is the entire system that must be modified in order to fulfill the conditions of immunity to noise. To this end, it will be necessary to modify the positioning of the components, the distribution of the input/output signals at the terminals of the integrated circuits and, if necessary, to introduce shielding around the victims of the noise. A failure of the test in the best case can also dictate the use of a costlier package for the integrated circuits.

If the sensitivity test fails in the worst case but succeeds in the best case, then certain aspects of the system have to be modified. Other models can also be implemented, for example a model of the medium case in which the system is modeled with noise sources that inject a medium noise into the substrate. All these models of the system and the tests of noise sensitivity related to them give indications on the immunity to noise of the system to be tested.

It must be noted that the extreme cases of noise injection are prepared in taking account of the reality of their occurrence. Indeed, for the best and worst cases to have meaning it must be possible to encounter them in a mode of operation of the system. The worst case (and the best case respectively) are therefore not excessively pessimistic (or excessively optimistic) so as to give a precise idea of the immunity to noise of the system studied.

To model the digital system and the noise injection in the above-mentioned different cases, a macro-model is defined, for each circuit of the system, of the noise injected into the system through the substrate, the interconnections and the package of the cells. This macro-model has a set of sources representing the different noise-injection modes (worst and best cases) as well as a set of passive elements, especially capacitors, resistors and inductors which reflect the parasitic interactions between the different sources of the model as well as the couplings with the substrate, the interconnections, and the package components. In practice, to determine the best and worst cases, the modeling of the noise sources is adjusted, with the passive elements of the macro-models of the circuits remaining identical from one case to another.

To this end, the current sources of this macro-model are extracted. For this purpose, first of all each cell is modeled as precisely as possible through the use of the most complete possible models of transistors available in the design kit of the elementary digital cells (or Corelib). Then, a test environment is defined for the cell to be tested, this environment being defined by input voltage sources comprising a particular rise/fall time between two changes in state, a capacitive load connected to each output of the cell as well as a power supply model.

The input voltage sources are subjected to switching patterns. These switching patterns define the passage of the inputs of the cell from one voltage level to another. These patterns may be exhaustive, i.e. all the possible input variations will be input to the cell or they may be pseudo-exhaustive i.e. only one part of the possible input variations will be input to the cell.

A SPICE simulation of the cell in its test environment gives waveforms (one waveform per switching pattern) for which a statistical classification is made. These waveforms may thus be classified as a function of their spectral density. To this end, the waveforms are transposed into the frequency domain and are then approximated by polynomial functions which facilitate the storage of these waveforms and their re-use to reconstitute a sum of currents injected into the system by a given block.

It is deemed to be the case that the greater the spectral density of a waveform, the greater is the noise generated (worst case). And the smaller the spectral density of a waveform, the smaller is the noise generated (best case). For each cell, it is thus possible to identify and extract noise sources for the worst case, the best case and the medium case. These noise sources are kept in a memory and are re-utilized from one system to another.

Digital blocks are then defined. These digital blocks comprise a set of digital cells. Thus, the term “circuit in an electronic system” is understood to mean elements that can be found at different hierarchical levels of blocks. The first level is that of a component such as a transistor. The second level is that of an elementary function such as an AND gate or an OR gate. The third level is that of an assembly of elementary functions used to fulfill a determined function, the number of hierarchical levels being unlimited.

For the blocks of the system, an equivalent injection model is defined, modeling the injection of current noise during inrush current surges in the cells. To this end, the invention chooses a modeling of the switching activity that defines the instant at which the digital blocks or the cells forming them inject their noise into the system. The noise may thus be computed in the system for blocks of different hierarchical levels. The noises of these blocks can then be combined with one another to compute the total observable noise in the system.

This injection model can be refined in terms of definition of the macro-model, definition of the sets of parameters chosen for the extraction of the current sources in the different cases envisaged, and the re-use of the noise sources within a block according to a description of the instants of switching of the cells.

The method of the invention can be implemented with an electronic system comprising a single integrated circuit on silicon in its package, several integrated circuits on silicon in a package or several electronic components with, optionally, integrated circuits connected to a printed circuit.

The invention therefore relates to a method for the estimation of a noise generated in a combined digital and analog and/or radio-frequency type system, this system comprising elementary cells that each fulfill a function, this method comprising the following steps:
modeling each digital and/or analog and/or radio-frequency cell by means of a noise injection macro-model, this macro-model comprising current sources to model the noise injected into the system by the cell,
extracting the current sources of the macro-models by simulation;
defining a model of distribution of the instants of switching of the digital cells, this distribution model defining the instants at which the cells of the systems switch over;
re-using the current sources extracted in the macro-models according to the distribution model defined, and
computing the observable noise within the system,
   characterised in that the step for re-using the sources within the macro-models comprises the following step:
injecting a marginal noise into the system that can be injected by the current sources, this marginal noise being possibly the worst and the best noise that can be injected by the current sources during the functioning of the system, the worst noise being the highest-level noise that can be injected by the current sources during the functioning of the system, the best noise being the lowest-level noise that can be injected by the current sources during the functioning of the system.

The invention furthermore relates to a method for testing the immunity to noise of a combined digital and/or analog and/or radio frequency type system, this system comprising cells connected to one another through nodes of the circuit, each node corresponding to a connection between two cells or between a cell and a power supply network of the system, this method comprising the following steps:
modeling the digital cells by means of macro-models, these macro-models comprising RLC type connection elements and noise sources which model a noise injection by the cells in the system,
connecting these macro-models with the rest of the system by means of the connection elements of these macro-models,
using noise sources extracted in the macro-models so as to inject noise into the system,
computing the noise levels in each node of the system, and
performing a test of sensitivity of this system to the noise injected, the test being successful if the computed noise is smaller than the sensitivity thresholds of the system and failing if the computed noise is greater than the same sensitivity thresholds,
   characterised in that the step for re-using sources within the macro-models comprising the following steps:
injecting the worst noise that can be injected by the cells into the system, this worst noise being the greatest noise that can be injected into the system by the cells during the operation of the system, and
if the sensitivity test is successful with the worst noise injected, accepting the circuit.

The invention will be understood more clearly from the following description and from the accompanying figures. These figures are given purely by way of an illustration and in no way restrict the scope of the invention. Of these figures:

FIG. 1 is a schematic view of a classic combined electronic system comprising digital and analog cells;

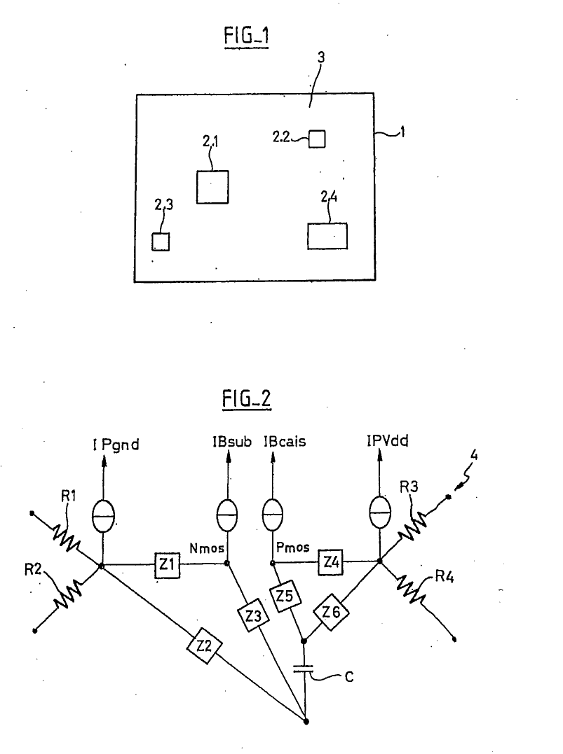

FIG. 2 is a schematic view of a prior-art macro-model modeling a digital cell;

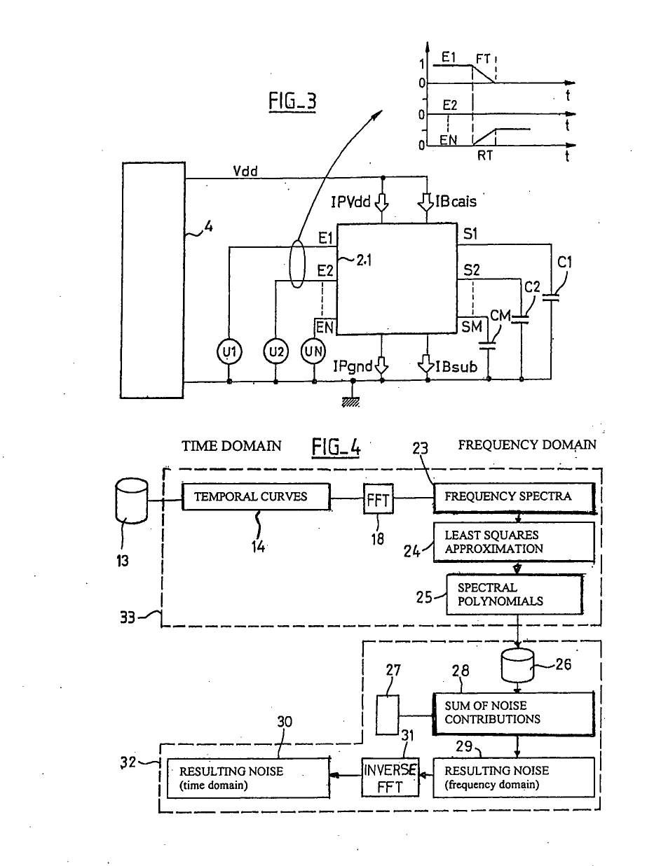

FIG. 3 is a schematic view of a cell and its test environment for the extraction of the noise sources in the method according to the invention;

FIG. 4 is a block diagram representing the steps of extraction of the noise sources of the macro-models and the re-use of these sources in the method according to the invention;

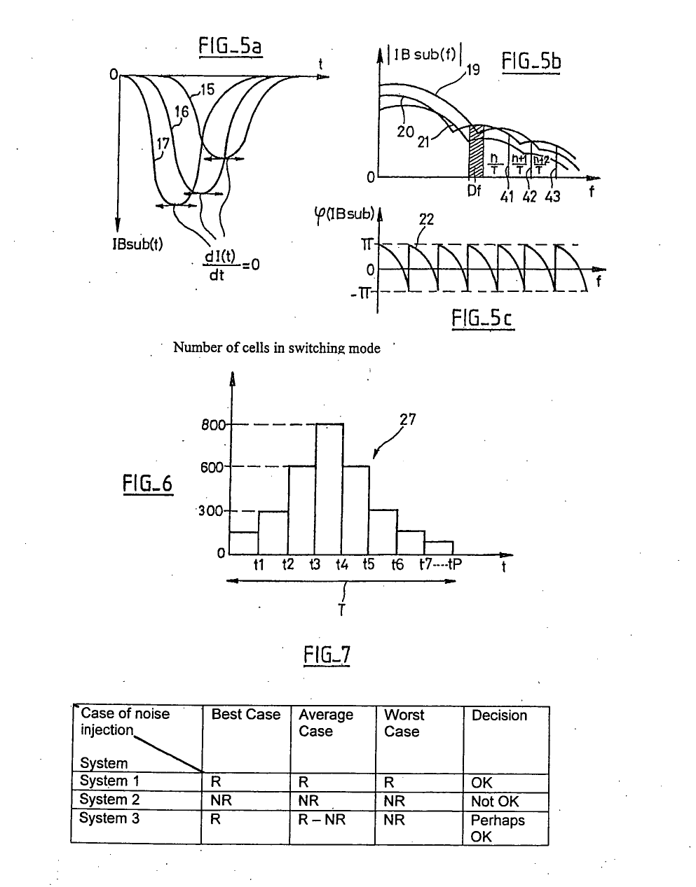

FIG. 5 are graphic depictions of waveforms obtained in the time domain and in the frequency domain for different switching patterns during the extraction of the noise sources according to the invention;

FIG. 6 is a histogram representing the number of cells of the system liable to be called at each time interval [ti ;ti+1 [;

FIG. 7 is a table according to the invention indicating a decision of acceptance or non-acceptance of systems as a function of the results of sensitivity tests in different cases of operation of these systems.

The identical elements keep the same reference from one figure to the next.

FIG. 1 shows an integrated circuit 1 comprising digital and analog circuits 2.1-2.4 performing elementary functions. These cells, which may for example be sets of logic gates, are mounted on a substrate 3 of this circuit 1. The digital cells inject a noise into this circuit when they operate in switching mode.

The injection of the noise from each digital cell into the substrate 3 can be modeled by a known macro-model 4 represented in FIG. 2. This macro-model 4 has four current sources IPvdd, IPgnd, IBsub and IBcais which model the noise that is generated by the switching of the NMOS and PMOS transistors and is injected into the rest of the circuit 1, i.e. the substrate 3 and the set of interconnections and power supply networks of the circuit 1.

More specifically, the current IPvdd is a current consumed by the cell for the switching operation. The current IPgnd is different from the current provided IPvdd since a part of the current provided IPvdd is shunted towards the output loads and to the substrate 3 of the circuit. The current IBsub is a leakage current leaking towards the substrate while the current IBcais is a leakage current leaking towards the well of the circuit 1.

Furthermore, the links between the terminals of the cell and the substrate 3 are modeled by these impedances Z1-Z6 connected to one another. Furthermore, a capacitor C connecting two resistor networks models the link between the part of the N doped substrate and the P doped substrate. The macro-model 4 is connected to the rest of the integrated circuit 1 by means of resistors R1-R4. The values of the elements Z1-Z6, C and R1-R4, which depend especially on a geometry of the cell, are known in principle for each cell studied.

As a variant, the macro-models may comprise several power supplies. The parasitic elements of the NMOS and PMOS structures can also be modeled differently.

Naturally, other macro-models can be implemented in the method according to the invention.

To extract the current sources from the macro-model 4, each cell 2.1-2.4 is modeled in a test environment. The cell 2.1 which comprises inputs E1-EN and outputs S1-SM is thus represented in its test environment in FIG. 3. The term “test environment” is understood to mean all the parameters external to the cell that have an influence on its behaviour, especially on the noise that it is capable of injecting into the circuit 1.

More specifically, this cell 2.1 is modeled by means of a model contained in a set of data files known as Designkit. These data files are used by the VHDL, SPICE or VITAL type digital circuit design and verification software programs. This model sets up models precisely of each physical phenomenon occurring in the cell 2.1 and enables a modeling of the different modes of noise injection of the transistors that form it. In one example, the cell 2.1 is modeled by an EKV, MM9, BSIM3v3 or BSIM4 type SPICE model and various parasitic elements such as capacitors, resistors and diodes.

The cell 2.1 is powered by a generator 4 which can be modeled as being ideal. However, it is also possible to implement a model of generator that models the parasites and couplings of the power supply lines up to each digital cell.

In this environment, the rise time RT and the fall time FT of the signals U1-UN applied to the inputs E1-EN of the cell 2.1 are fixed. This rise time RT and fall time FT can be the minimum, maximum or medium switch-over times of the digital cells likely to control the inputs of the cell considered. The shorter the rise time (i.e. the more sudden the switching), the greater is the noise injected by the observable cell. Conversely, the lengthier the rise time, the lower the noise injected by the cell.

Furthermore, the value of the capacitive loads C1-CM connected to the outputs S1-SM of the cell 2.1 is fixed. These loads C1-CM correspond to an internal input capacitance of the following cells connected to the outputs of the cell 2.1. Several sets of capacitances can be used, the values of the output capacitances influencing the switching times of the cells as well as the noise generated by the cell 2.1 when switching.

A definition is then made of the switching patterns that will be applied to the inputs E1-EN of the circuit by means of U1-UN. It may be recalled that these patterns define the passage of the levels of the inputs of the cell from one state to another. A switching pattern is represented for example at the top right-hand side of FIG. 3. Initially, the number of states that can change in the pattern is defined. Then, it may be chosen to bring about variation in the inputs E1-EN according to a Gray type code. In this case, only one input changes in a switching pattern. As a variant, it is chosen to make several inputs vary at the same time in the switching pattern. As a variant, it is possible to take account of the time lags between the changes in state of the inputs.

In a second stage, a number of switching patterns to be applied to the inputs E1-EN is chosen. It is thus possible to choose to apply all the possible patterns at input, i.e. 2^{N}.(2^{N}−1) patterns. However, such a choice requires very lengthy execution time. Hence preferably a limited number of patterns will be chosen by a random draw of the patterns which will be simulated, all the patterns being considered to be equiprobable. Experience shows that limiting patterns in this way provides for a relevant estimation of the worst-case and best-case waveforms provided that the size of the sample or estimator is sufficient. This limiting of the patterns provides for a gain in time in the extraction of the current sources and makes it easy to integrate the current source extraction tool of the invention into a software program. As a variant, the patterns can be weighted so as to take account of those patterns that are most likely to be observed at input of the cell 2.1.

Once the test environment is defined, the different switching patterns are applied to the inputs of the cell 2.1. For each switching pattern, simulation data stored in a memory 13 shown in FIG. 4 is obtained.

Thus, FIG. 5a shows the temporal waveforms 15-17 of the noise source IBsub for three different switching patterns. These waveforms 15-17 may have different minimum and maximum values I(t) and dl/dt at different points in time. It is therefore quite difficult to find out which waveform represents the worst case or the best case. The effect of these waveforms on the victims is furthermore difficult to estimate.

These temporal waveforms 15-17 are transposed to the frequency domain by means of a Fourier transform cell 18. Then, frequency spectra are obtained, the magnitude 19-22 of which is shown in FIG. 5b and the phase 22 of which, oscillating between −pi and +pi, is shown in FIG. 5c. The waveforms are stored and re-utilized in their spectral form owing to the nature of the analysis algorithms of the system which implement a matrix resolution for each frequency and owing to the nature of the victims which are analog or radio frequency type victims.

Then, in a step 24, a least squares approximation technique is performed on the real and imaginary parts of the frequency spectra. This step 24 enables an approximation of each frequency spectrum 19-22 by two polynomials: first polynomial approaching the real part of the spectrum and a second polynomial approaching the imaginary part of the spectrum. Then, a set of polynomials 25 is obtained, the coefficients of which are stored in a memory 26.

A storage of coefficients of this kind has the advantage of taking up less space than the storage of the points of the spectra and of enabling a re-use of the waveforms to reproduce different values of periods of the same signal corresponding to spacings of lines in the frequency domain. Indeed, it is possible to reuse the spectra for different periods of the waveforms, it being possible to select lines of these spectra 41-43 that are multiples of 1/T, T being the clock period. Another advantage of the storage of the polynomials is the reduction of the execution time during the computation of the sums of spectra for the computation of noise of a block as well as high precision of the result obtained.

The blocks 14, 18, 23-25 forming the block 33 thus represent the steps of extraction of the noise sources of the macro-models. Once the noise sources have been extracted, a statistical classification is made of the spectra obtained so as to identify the minimum and maximum noise sources of each cell corresponding to a worst case and a best case of noise injection by the cell.

To this end, the spectral densities of the spectra are computed from their spectral lines. To obtain a classification of the spectra according to their noise level, it is deemed to be the case that the greater the spectral density, the greater is the noise level. And the lower the spectral density, the lower is the level of noise generated by the cell. Thus, the worst case source is extracted from the cell by extraction of the waveform with the greatest spectral density. And, the best case source is extracted by extraction of the waveform with the lowest spectral density.

The spectral density can be computed throughout the frequency spectrum. However, this spectral density can also be computed for a range of frequencies DF or for a particular frequency line. Different classifications of waveforms are possible depending on the type of computation of spectral density chosen and the range of frequencies chosen. In this step, it is also possible to determine a mean spectrum, a standard deviation between the spectra or any other piece of statistical data giving an indication concerning the noise that can be injected by the cells.

As a variant, other methods could be used to compare the different spectra with one another and classify them.

The following blocks 26-30 of FIG. 4 represent a phase 32 for rebuilding a noise model for a digital circuit. In other words, these blocks 26-30 represent steps for using macro-models and extracted current sources to compute a worst case noise, best case noise or any other possibility in a particular circuit.

More specifically, during this rebuilding phase, the best case or worst case noises 26 for each cell are injected in spectral form in taking account of the switching times of the cells.

To this end, the invention uses a model 27 which models the switching instants of the cells in time. This model 27 makes it possible to determine the progress in time of the number of cells called, i.e. the progress in time of the number of cells in switching mode.

FIG. 6 thus gives the example of a histogram modeling a discrete distribution of inrush current surges during a clock period T. This graph indicates the number of cells (an integer) likely to be called at each time interval [ti, ti+1[. The instants t1-tP constitute a discrete chopping of the period T into P time intervals.

During each period T, the number of cells in switching mode evolves, and the digital cells transmit the signals from one cell to the next. This graph thus models a switching activity proper to each clock period, this activity being linked to a modification of the inputs of a digital block. The number of cells in switching mode increases until it reaches a peak. This increase depends on a fan-out parameter which indicates the number of cells connected to the output of each cell whose outputs change their state. After the peak, the number of cells in a switching state diminishes until it reaches zero.

From the switching activity model 27, it is possible to determine the instant at which the cells inject their noise into the substrate. A switching delay relative to a circuit clock signal edge is then associated with each cell, this delay representing the effective call time of the cell and hence the moment at which the noise is injected into a cell. Depending on the case chosen (the best case or the worst case), the switching activity model of the cells can also be adapted. In particular, the number of cells capable of switching and therefore injecting their noise can vary from one case to another.

Furthermore, different noise injection spectra are associated with each cell depending on the case of operation chosen. In the worst case of operation, it is assumed that most of the cells or all the cells inject the extracted waveform corresponding to their maximum noise. In the best case of operation, it is assumed that most of the cells or all the cells inject the extracted waveform corresponding to their minimum noise. In the medium case of operation, computations are made on the extracted waveforms to determine the medium waveforms of the noise sources of each cell. For a large number of cells called, it is possible to choose the waveforms randomly from among those that are extracted and available for each cell.

Each cell therefore has an associated noise spectrum and an associated noise injection time. A frequency sum of these spectra and of these delays is then obtained in a step 28. A resulting noise spectrum 29 is then obtained in the frequency domain. Then, depending on the requirements of the analysis of the system, this noise spectrum 29 can then be converted into a resultant noise time signal by means of an inverse Fourier transform cell 31. The block 32 thus makes it possible to obtain a temporal or frequency waveform of noise that can be injected by a digital block using knowledge of the noise sources of the extracted cells internal to this block and of a switching model.

To know if the circuit 1 is sensitive to the resulting noise, a noise sensitivity template is considered for each victim. This template gives the noise sensitivity threshold of the victim for each frequency. Then, a test of noise sensitivity is performed by comparing the computed block noise and the template.

The table of FIG. 7 indicates the decisions of acceptance or non-acceptance of three systems as a function of a result of their sensitivity test performed in the worst case, the medium case and the best case of noise injection. The letter R signifies that the test performed by the system has been successful, i.e. that the noise level computed in the system is acceptable given the sensitivity templates of the victims considered or the sensitivity test protocols for each victim. The letter NR signifies that the test performed on the system has failed, i.e. that the noise level computed in the system is not acceptable given the sensitivity templates considered or the sensitivity test protocols for each victim.

More specifically, the system 1 has successfully undergone the noise sensitivity test in the worst case, the best case and the medium case of noise injection. The system 1 therefore has high immunity to noise and is therefore considered to be acceptable. This decision is taken when the test performed with the worst noise is successful. Thus, it is certain that the system works whatever the level of noise injected in all its modes of use, including the marginal modes.

With the system 2, the noise sensitivity test has failed for all the cases of noise injection. The system 2 is therefore considered to possess poor noise immunity and must therefore be discarded from production. This choice is made when it is clear that the sensitivity test has failed in the best case of noise injection. Thus, it is certain that the system 2 will never be able to perform properly.

With the system 3, the noise sensitivity test has been successful in the best case and the medium case but has failed in the worst case of injection. Thus, it is difficult to determine if the system 3 is acceptable or not. To refine the analysis, it is possible to perform tests by injecting intermediate noise levels into the system. In all likelihood, modifications of architecture of the system 3 will have to be done so that this system 3 becomes acceptable.

In one mode of implementation of the method of the invention, a sensitivity test is first of all conducted with the worst case, then with the best case and finally with the medium case. Thus, it is possible to know very soon if a system has high immunity to noise. If the worst case has failed, other additional analyses are needed (best case medium case) to deepen the analysis of the system.

It can be noted that the worst case (and the best case respectively) of operation is not necessarily obtained by a choice of the worst (or respectively the best) switching, environment and noise source parameters for the different cells. Indeed, these different cases of operation should be observable in real operation of the system. In other words, these cases of operation are not artificial cases but cases which can be encountered when the system works within its limits. It can happen therefore that a choice of all the worst (and best) noise injection parameters respectively does not correspond to the worst (and, respectively, best) case of noise injection of a given system because such a case could never occur.

Tests and experiments can be used to orient the relevant modeling choices for the worst (and respectively best) cases which should not be too pessimistic (or too optimistic respectively).

Naturally, the different steps of the method of the invention can be updated by an electronic circuit or by means of a software program executed by a computer, the software program being recorded on a USB memory, DVD, CD or floppy type carrier.

1-16. (canceled)

17. A method for the estimating noise generated in a combined digital and analog and/or radio-frequency type system, the combined system comprises elementary cells, each elementary cell performing a function, the method comprising the steps of:
modeling each elementary cell of the combined system by a noise injection macro-module, said noise injection macro-model comprising current sources to model the noise injected into the combined system by said each elementary cell;
extracting the current sources of said noise injection macro-models by simulation;
defining a model of distribution of instants of switching of said elementary cells, the distribution model defining the instants at which said elementary cells of the combined system switch over;
re-using the current sources extracted in said noise injection macro-models according to the distribution model; and
computing observable noise within the combined system; and
wherein the step of re-using further comprises the step of injecting a marginal noise into the combined system that can be injected by the current sources, said marginal noise being either worst or best noise that can be injected by the current sources during operation of the combined system;
wherein the worst noise being, as expressed in a frequency domain, highest-level noise that can be injected by the current sources during the operation of the combined system; and
wherein the best noise being, as expressed in the frequency domain, lowest-level noise that can be injected by the current sources during the operation of the combined system.

18. The method of claim 17, wherein the combined system is an integrated circuit, said elementary cells being made on a substrate of said integrated circuit; and wherein the step of modeling comprises the step of macro-modeling noise current being propagated in the substrate, interconnections of said integrated circuit and in a package of said integrated circuit.

19. The method of claim 18, wherein the step of extracting comprises the steps of:
modeling transistors that form said each elementary cell;
defining a test environment for said each elementary cell based on parameters that have influence on the noise generated by said each elementary cell;
applying different switching patterns to input terminals of said each elementary cell using voltage sources connected to the inputs terminals to obtain a noise source waveform for each switching pattern;
classifying source noise waveforms as a function of a noise level associated with the source noise waveforms; and
storing noise sources associated with the source noise waveforms and said noise injection macro-model of said each elementary cell in a memory.

20. The method of claim 19, wherein the step of modeling each elementary cell utilizes one of the following model: MM9, BSIM3 or BSIM4 type SPICE model.

21. The method of claim 19, wherein the step of defining the test environment comprises the steps of:
fixing a rise time (RT) and a fall time (FT) of signals of the current sources at an input of said each elementary cell; and
fixing a value of a capacitive load connected to different outputs of said each elementary cell.

22. The method of claim 21, wherein the step of defining the test environment further comprises the step of modeling a power supply network of said each elementary cell considering parasites and power line couplings of said power supply network connected to terminals of said each elementary cell.

23. The method of claim 19, further comprising the step of randomly drawing a sample of switching patterns to be applied to the input terminals of said each elementary cell from among all the possible switching patterns, these possible switching patterns being considered to be equally probable.

24. The method of claim 19, wherein the step of classifying comprises the steps of:
computing frequency spectra of the source noise waveforms by Fourier transform;
computing spectral densities of the frequency spectra; and
classifying the source noise waveforms as a function of spectral density values.

25. The method of claim 24, wherein the step computing spectral densities comprises the step of computing the spectral densities of the frequency spectra on an entire spectrum, on a frequency range (Df), or for a particular spectral line.

26. The method of claim 24, further comprising the steps of:
selecting a noise source waveform which comprises a highest spectral density as a worst noise source of said noise injection macro-model; and
selecting a noise source waveform which comprises a lowest spectral density as a best noise source of said noise injection macro-model.

27. The method of claim 19, further comprising the steps of:
computing, for each noise source waveform, a first polynomial which approaches a real part of a frequency spectrum of said each noise source waveform and a second polynomial which approaches an imaginary part of the frequency spectrum of said each noise source waveform by a least squares approximation method; and
storing, for said each noise source waveform, coefficients of the first and second polynomials in a memory so that size of the source noise waveforms is reduced relative to a storage of points of an entire spectrum.

28. The method of claim 27, wherein the step of computing observable noise within the combined system further comprises the steps of:
computing a sum of frequency spectra of the source noise waveforms of different elementary cells using the first and second polynomials associated with said each elementary cells such that computation time of said sum being shorter than computation time needed to compute a sum of the source noise waveforms in a time domain; and
reusing the first and second polynomials of the frequency spectra for different periods of the source noise waveforms to select lines of the spectra that are multiples of 1/T, T being a clock period of said integrated circuit.

29. A method for testing immunity to noise of a combined digital and/or analog and/or radio frequency type system, said combined system comprising digital cells connected to one another through nodes of a circuit, each node corresponding to a connection between two digital cells or between a digital cell and a power supply network of the combined system, the method comprising the steps of:
(a) modeling the digital cells using macro-models comprising RLC type connection elements and noise sources which model a noise injection by the digital cells in the combined system;
(b) connecting the macro-models with the rest of the combined system using the RLC type connection elements of the macro-models;
(c) using noise sources extracted in the macro-models so as to inject noise into the combined system′
(d) computing noise levels in each node of the combined system;
performing a sensitivity test of sensitivity of the combined system to the noise injected, the sensitivity test being successful if computed noise is smaller than the sensitivity thresholds of the combined system and failing if the computed noise is greater than the sensitivity thresholds;
(e) re-using sources within the macro-models by injecting worst noise that can be injected by the digital cells into the combined system, the worst noise being greatest noise that can be injected into the combined system by the digital cells during operation of the combined system, and accepting the circuit if the sensitivity test is successful with the worst noise injected.

30. The method of claim 29, further comprising the following steps if the sensitivity test with the worst noise injected fails:
injecting into the combined system best noise that can be injected by the digital cells, the best noise being the lowest noise that can be injected into the combined system by the digital cells during the operation of the system; and
discarding the combined system if the sensitivity test fails.

31. The method of claim 29, further comprising the following step if the sensitivity test fails with the worst noise but is successful with the best noise:
injecting into the combined system a medium noise that can be injected by the digital cells during the operation of the combined system; and
modifying an architecture of the circuit and repeating steps (a)-(e).

32. A device operable to estimate noise generated in a combined digital and analog and/or radio-frequency type system, the combined system comprises elementary cells, each elementary cell performing a function, the device performing the following functions:
modeling each elementary cell of the combined system by a noise injection macro-module, said noise injection macro-model comprising current sources to model the noise injected into the combined system by said each elementary cell;
extracting the current sources of said noise injection macro-models by simulation;
defining a model of distribution of instants of switching of said elementary cells, the distribution model defining the instants at which said elementary cells of the combined system switch over;
re-using the current sources extracted in said noise injection macro-models according to the distribution model; and
computing observable noise within the combined system; and
wherein the step of re-using further comprises the step of injecting a marginal noise into the combined system that can be injected by the current sources, said marginal noise being either worst or best noise that can be injected by the current sources during operation of the combined system;
wherein the worst noise being, as expressed in a frequency domain, highest-level noise that can be injected by the current sources during the operation of the combined system; and
wherein the best noise being, as expressed in the frequency domain, lowest-level noise that can be injected by the current sources during the operation of the combined system.

33. A device operable to test immunity to noise of a combined digital and/or analog and/or radio frequency type system, said combined system comprising digital cells connected to one another through nodes of a circuit, each node corresponding to a connection between two digital cells or between a digital cell and a power supply network of the combined system, the device performing the following functions:
(a) modeling the digital cells using macro-models comprising RLC type connection elements and noise sources which model a noise injection by the digital cells in the combined system;
(b) connecting the macro-models with the rest of the combined system using the RLC type connection elements of the macro-models;
(c) using noise sources extracted in the macro-models so as to inject noise into the combined system′
(d) computing noise levels in each node of the combined system;
performing a sensitivity test of sensitivity of the combined system to the noise injected, the sensitivity test being successful if computed noise is smaller than the sensitivity thresholds of the combined system and failing if the computed noise is greater than the sensitivity thresholds;
(e) re-using sources within the macro-models by injecting worst noise that can be injected by the digital cells into the combined system, the worst noise being greatest noise that can be injected into the combined system by the digital cells during operation of the combined system, and accepting the circuit if the sensitivity test is successful with the worst noise injected.
